(19) United States
(12) Patent Application Publication
(10) Pub. No.: US 2013/0294123 A1
(43) Pub. Date: Nov. 7, 2013

(54) CHARGE PUMP

(71) Applicant: Ili Technology Corporation, Jhubei City (TW)

(72) Inventors: Chen-Jung Chuang, New Taipei City (TW); Wei-Chih Chen, Guishan Township (TW)

(21) Appl. No.: 13/664,712

(22) Filed: Oct. 31, 2012

(30) Foreign Application Priority Data
Mar. 13, 2012 (TW) 101108476

(51) Int. Cl. H02M 3/07

(52) U.S. Cl. CPC H02M 3/07
USPC 363/60

(57) ABSTRACT

A charge pump includes a timing signal generator for generating complementary first and second timing signals, and a voltage booster including a plurality of voltage boosting circuits. Each of the voltage boosting circuits includes input and output terminals, first and second capacitors each having first and second ends, and a switch module. The switch module is controllable to make or break electrical connection between the second end of the first capacitor and each of the input and output terminals and between the second end of the second capacitor and each of the input and output terminals. The first end of each of the first and second capacitors of a first one of the voltage boosting circuits receives a respective one of the first and second timing signals.

### CROSS-REFERENCE TO RELATED APPLICATION

This application claims priority of Taiwanese Patent Application No. 101108476, filed on Mar. 13, 2012.

### BACKGROUND OF THE INVENTION

1. Field of the Invention

The present invention relates to a charge pump, more particularly to a charge pump which can save chip area thereof.

2. Description of the Related Art

In U.S. Pat. No. 7,145,382, a conventional charge pump circuit is illustrated. Referring to FIG. 3(a) of this patent, the charge pump circuit includes four stages of voltage amplifying circuits. Each stage has a first timing input coupled to one of a pair of complementary timing signals (Φ1 or Φ2) and a second timing input coupled to the other of the pair of complementary timing signals (Φ2 or Φ1). Each first timing input of the four stages is alternately coupled to a different one of the pair of complementary timing signals, and each second timing input of the four stages is alternately coupled to a different one of the pair of complementary timing signals.

Each of the four stages of the voltage amplifying circuits includes a first capacitor and a second capacitor. The first capacitor has a terminal defining the first timing input, and the second capacitor has a terminal defining the second timing input. Each of the pair of complementary timing signals Φ1, Φ2 is switchable between a logic 0 state (voltage 0) and a logic 1 state (voltage VDD).

Referring to FIG. 3(b) of this patent, a voltage signal diagram of the charge pump circuit illustrates the waveforms at nodes 1˜8. It is noted from the waveforms that the voltage across each of the first and second capacitors of the first stage is VDD, the voltage across each of the first and second capacitors of the second stage is 2×VDD, the voltage across each of the first and second capacitors of the third stage is 3×VDD, and the voltage across each of the first and second capacitors of the fourth stage is 4×VDD.

The conventional charge pump circuit has the drawbacks that the voltage across the respective capacitor is proportional to the stage of the voltage amplifying circuit where the respective capacitor belongs. Therefore, to enable a capacitor to endure a higher voltage, the capacitor is formed from a large number of series-connected sub-capacitors, such that an overall chip area of the charge pump circuit is increased.

### SUMMARY OF THE INVENTION

Therefore, an object of the present invention is to provide a charge pump which can save chip area thereof.

Accordingly, the charge pump of the present invention comprises a timing signal generator and a voltage booster.

The timing signal generator is configured for generating a first timing signal and a second timing signal that is an inverse of the first timing signal.

The voltage booster includes a series connection of a plurality of voltage boosting circuits. Each of the voltage boosting circuits includes a bias voltage input terminal, a bias voltage output terminal, a first capacitor having a first end and a second end, a second capacitor having a first end and a second end, and a switch module.

The switch module is coupled electrically to the bias voltage input terminal, the bias voltage output terminal, and the second ends of the first and second capacitors, and is controllable to switch between a first state, in which electrical connection is established between the second end of the first capacitor and the bias voltage output terminal and between the second end of the second capacitor and the bias voltage input terminal, and a second state, in which electrical connection is established between the second end of the first capacitor and the bias voltage input terminal and between the second end of the second capacitor and the bias voltage output terminal.

The bias voltage input terminal of a first one of the voltage boosting circuits in the series connection is adapted to receive an input bias voltage signal. The bias voltage input terminal of each of succeeding ones of the voltage boosting circuits in the series connection is coupled electrically to the bias voltage output terminal of an immediately preceding one of the voltage boosting circuits in the series connection. Each of the voltage boosting circuits is configured to boost a voltage signal received at the bias voltage input terminal thereof and to output the voltage signal boosted thereby from the bias voltage output terminal thereof.

The bias voltage output terminal of a last one of the voltage boosting circuits in the series connection is adapted to provide an output bias voltage.

The first end of the first capacitor of the first one of the voltage boosting circuits in the series connection is coupled electrically to the timing signal generator for receiving the first timing signal, and the first end of the first capacitor of each of the succeeding ones of the voltage boosting circuits in the series connection is coupled electrically to the second end of the first capacitor of the immediately preceding one of the voltage boosting circuits in the series connection.

The first end of the second capacitor of the first one of the voltage boosting circuits in the series connection is coupled electrically to the timing signal generator for receiving the second timing signal, and the first end of the second capacitor of each of the succeeding ones of the voltage boosting circuits in the series connection is coupled electrically to the second end of the second capacitor of the immediately preceding one of the voltage boosting circuits in the series connection.

Another object of the present invention is to provide a voltage booster.

The voltage booster of the present invention is to be utilized in a charge pump. The charge pump includes a timing signal generator for generating a first timing signal and a second timing signal that is an inverse of the first timing signal. The voltage booster comprises a series connection of a plurality of voltage boosting circuits.

Each of the voltage boosting circuits includes a bias voltage input terminal, a bias voltage output terminal, a first capacitor having a first end and a second end, a second capacitor having a first end and a second end, and a switch module.

The switch module is coupled electrically to the bias voltage input terminal, the bias voltage output terminal, and the second ends of the first and second capacitors, and is controllable to switch between a first state, in which electrical connection is established between the second end of the first capacitor and the bias voltage output terminal and between the second end of the second capacitor and the bias voltage input terminal, and a second state, in which electrical connection is established between the second end of the first capacitor and the bias voltage input terminal and between the second end of the second capacitor and the bias voltage output terminal.

The bias voltage input terminal of a first one of the voltage boosting circuits in the series connection is adapted to receive an input bias voltage signal. The bias voltage input terminal of each of succeeding ones of the voltage boosting circuits in the series connection is coupled electrically to the bias voltage output terminal of an immediately preceding one of the voltage boosting circuits in the series connection. Each of the voltage boosting circuits is configured to boost a voltage signal received at the bias voltage input terminal thereof and to output the voltage signal boosted thereby from the bias voltage output terminal thereof. The bias voltage output terminal of a last one of the voltage boosting circuits in the series connection is adapted to provide an output bias voltage.

The first end of the first capacitor of the first one of the voltage boosting circuits in the series connection is coupled electrically to the timing signal generator for receiving the first timing signal, and the first end of the first capacitor of each of the succeeding ones of the voltage boosting circuits in the series connection is coupled electrically to the second end of the first capacitor of the immediately preceding one of the voltage boosting circuits in the series connection.

The first end of the second capacitor of the first one of the voltage boosting circuits in the series connection is coupled electrically to the timing signal generator for receiving the second timing signal, and the first end of the second capacitor of each of the succeeding ones of the voltage boosting circuits in the series connection is coupled electrically to the second end of the second capacitor of the immediately preceding one of the voltage boosting circuits in the series connection.

### BRIEF DESCRIPTION OF THE DRAWINGS

Other features and advantages of the present invention will become apparent in the following detailed description of a preferred embodiment with reference to the accompanying drawings, of which:

FIG. 1 is a schematic diagram of a preferred embodiment of a charge pump of the present invention;

FIG. 2 is a circuit diagram illustrating a voltage booster, which includes a series connection of first to third voltage boosting circuits, of the preferred embodiment;

FIG. 3 is a schematic diagram illustrating a first operation mode of the voltage boosting circuits in correspondence to first and second timing signals; and

FIG. 4 is a schematic diagram illustrating a second operation mode of the voltage boosting circuits in correspondence to the first and second timing signals.

### DETAILED DESCRIPTION OF THE PREFERRED EMBODIMENT

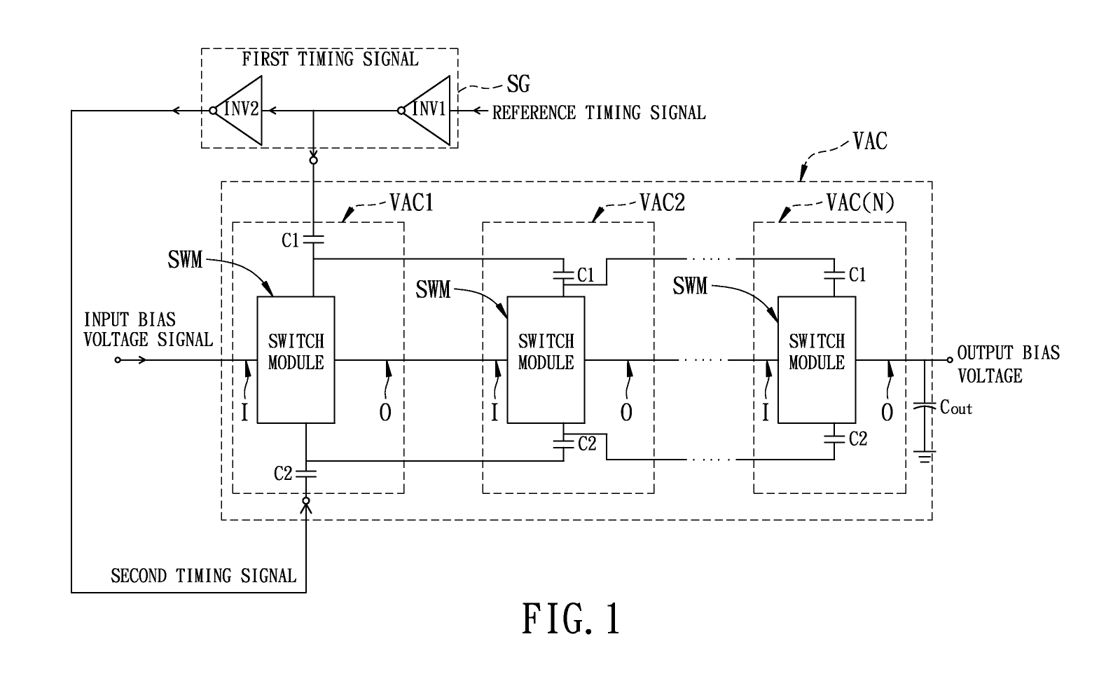

Referring to FIG. 1, a preferred embodiment of a charge pump according to the present invention comprises a timing signal generator SG, a voltage booster VAC, and an output capacitor Cₒᵤₜ.

The timing signal generator SG is configured for generating a first timing signal and a second timing signal that is an inverse of the first timing signal (i.e., the first and second timing signals are complementary). The timing signal generator SG includes a first inverter INV1 and a second inverter INV2. The first inverter INV1 has an input end for receiving a reference timing signal, and an output end for outputting the first timing signal. The second inverter INV2 has an input end coupled electrically to the output end of the first inverter INV1, and an output end for outputting the second timing signal.

The voltage booster VAC includes a series connection of a plurality of voltage boosting circuits VAC1˜VAC (N). Each of the voltage boosting circuits VAC1, VAC2, ˜, VAC (N) includes a bias voltage input terminal I, a bias voltage output terminal O, a first capacitor C1 having a first end and a second end, a second capacitor C2 having a first end and a second end, and a switch module SWM.

The switch module SWM is coupled electrically to the bias voltage input terminal I, the bias voltage output terminal O, and the second ends of the first and second capacitors C1, C2, and is controllable to switch between a first state, in which electrical connection is established between the second end of the first capacitor C1 and the bias voltage output terminal O and between the second end of the second capacitor C2 and the bias voltage input terminal I, and a second state, in which electrical connection is established between the second end of the first capacitor C1 and the bias voltage input terminal I and between the second end of the second capacitor C2 and the bias voltage output terminal O.

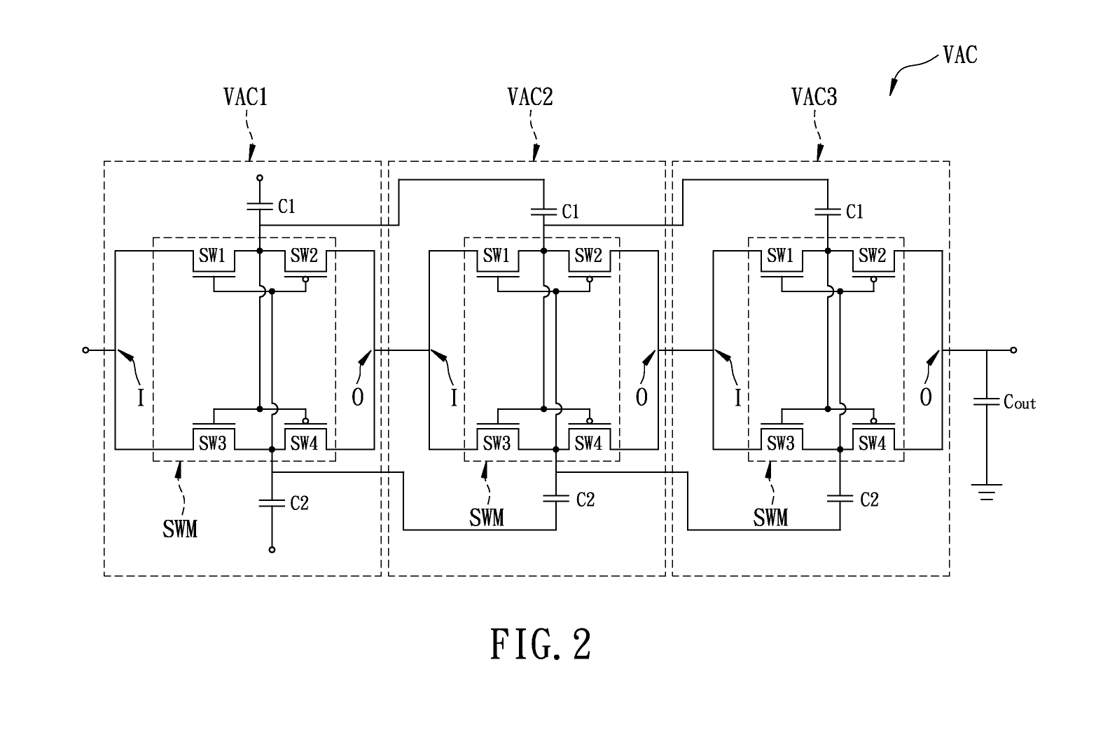

Referring to FIG. 2, it is noted that, for convenience of illustration, three voltage boosting circuits VAC1˜VAC3 are taken as an example for the voltage booster VAC. However, the number of the voltage boosting circuits is not limited to three in practical applications.

Each of the switch modules SWM includes first to fourth switches SW1˜SW4.

The first switch SW1 has a first end coupled electrically to the respective bias voltage input terminal I, a second end coupled electrically to the second end of the respective first capacitor C1, and a control end coupled electrically to the second end of the respective second capacitor C2. The control end is controllable to make or break electrical connection between the first and second ends of the first switch SW1.

The second switch SW2 has a first end coupled electrically to the second end of the respective first capacitor C1, a second end coupled electrically to the respective bias voltage output terminal O, and a control end coupled electrically to the second end of the respective second capacitor C2. The control end of the second switch SW2 is controllable to make or break electrical connection between the first and second ends of the second switch SW2.

The third switch SW3 has a first end coupled electrically to the respective bias voltage input terminal I, a second end coupled electrically to the second end of the respective second capacitor C2, and a control end coupled electrically to the second end of the respective first capacitor C1. The control end of the third switch SW3 is controllable to make or break electrical connection between the first and second ends of the third switch SW3.

The fourth switch SW4 has a first end coupled electrically to the second end of the respective second capacitor C2, a second end coupled electrically to the respective bias voltage output terminal O, and a control end coupled electrically to the second end of the respective first capacitor C1. The control end of the fourth switch SW4 is controllable to make or break electrical connection between the first and second ends of the fourth switch SW4.

In the preferred embodiment, each of the first and third switches SW1, SW3 is an N-type metal-oxide-semiconductor field-effect transistor (MOSFET) having source, drain and gate terminals serving as the first end, the second end and the control end, respectively. Each of the second and fourth switches SW2, SW4 is a P-type MOSFET having drain, source and gate terminals serving as the first end, the second end and the control end, respectively.

The bias voltage input terminal I of a first one of the voltage boosting circuits VAC1 in the series connection is adapted to receive an input bias voltage signal. The bias voltage input terminal I of each of succeeding ones of the voltage boosting circuits VAC2˜VAC(N) in the series connection is coupled electrically to the bias voltage output terminal O of an immediately preceding one of the voltage boosting circuits VAC1˜VAC (N−1) in the series connection. Each of the voltage boosting circuits VAC1, VAC2, ˜,VAC(N) is configured to boost a voltage signal received at the bias voltage input terminal I thereof and to output the voltage signal boosted thereby from the bias voltage output terminal O thereof. The bias voltage output terminal O of a last one of the voltage boosting circuits VAC (N) in the series connection is adapted to provide an output bias voltage.

The first end of the first capacitor C1 of the first one of the voltage boosting circuits VAC1 in the series connection is coupled electrically to the timing signal generator SG for receiving the first timing signal, and the first end of the first capacitor C1 of each of the succeeding ones of the voltage boosting circuits VAC2˜VAC(N) in the series connection is coupled electrically to the second end of the first capacitor C1 of the immediately preceding one of the voltage boosting circuits VAC1˜VAC(N−1) in the series connection.

The first end of the second capacitor C2 of the first one of the voltage boosting circuits VAC1 in the series connection is coupled electrically to the timing signal generator SG for receiving the second timing signal, and the first end of the second capacitor C2 of each of the succeeding ones of the voltage boosting circuits VAC2˜VAC(N) in the series connection is coupled electrically to the second end of the second capacitor C2 of the immediately preceding one of the voltage boosting circuits VAC1˜VAC(N−1) in the series connection.

When the first timing signal is at a logic 1 state and the second timing signal is at a logic 0 state, the switch module SWM of each of the voltage boosting circuits VAC1, VAC2, ˜, VAC(N) is controlled to operate in the first state.

On the other hand, when the first timing signal is at a logic 0 state and the second timing signal is at a logic 1 state, the switch module SWM of each of the voltage boosting circuits VAC1, VAC2, ˜, VAC(N) is controlled to operate in the second state.

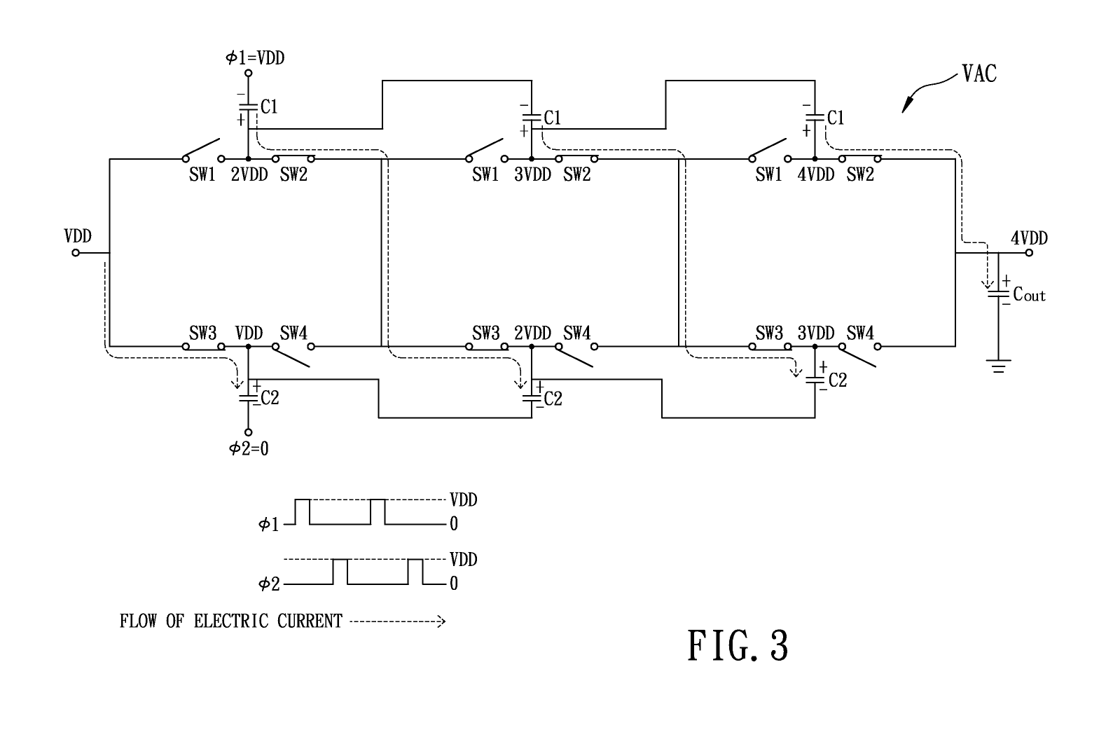

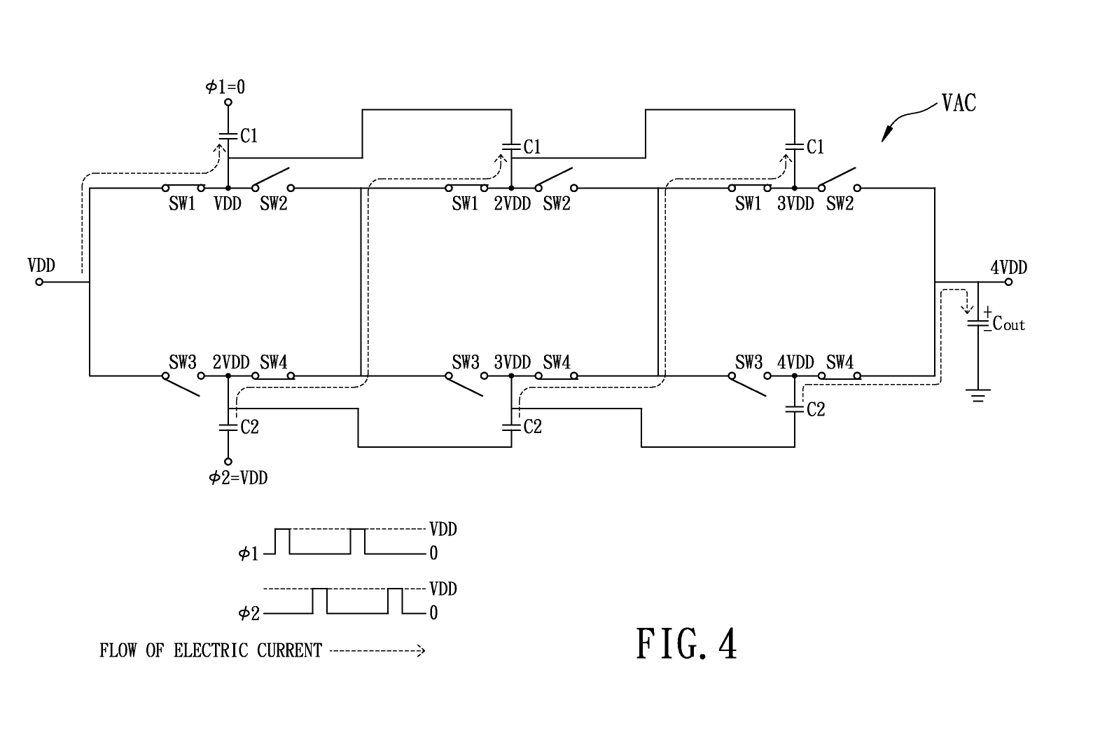

Referring to FIGS. 2 to 4, for the purpose of more clearly illustrating operation modes of the voltage boosting circuits VAC1, VAC2, ˜, VAC(N) in correspondence to the first and second timing signals Φ1,Φ2, each of the N-type MOSFETs and the P-type MOSFETs in FIG. 2 are illustrated in the form of a switch in FIGS. 3 and 4. Moreover, two ends of the switches SW1˜SW4 serve as the drain and source terminals, respectively, and the gate terminal and wires connected thereto are omitted. The input bias voltage signal has a voltage of VDD, and each of the first and second timing signals Φ1, Φ2 is switchable between the logic 0 state (voltage 0) and a logic 1 state (voltage VDD).

Referring to FIG. 3, a first operation mode is illustrated. When the first timing signal Φ1 has the voltage of VDD and the second timing signal Φ2 has the voltage of 0, the first end of the first capacitor C1 of the first one of the voltage boosting circuits VAC1 in the series connection has a voltage of VDD, and since the first capacitor C1 has been fully charged during a previous time cycle such that the second end thereof has a cross voltage of VDD with respect to the first end thereof, the second end of the first capacitor C1 has a voltage of 2VDD=VDD+VDD. The voltage of 2VDD (>VDD) is applied onto the control ends of the third and fourth switches SW3, SW4 so as to make the electrical connection between the first and second ends of the third switch SW3 and to break the electrical connection between the first and second ends of the fourth switch SW4. A flow of electric current from the bias voltage input terminal I charges the second capacitor C2 such that the second end of the second capacitor C2 has a voltage of VDD. The voltage of VDD (<2VDD) is applied onto the control ends of the first and second switches SW1, SW2 so as to break the electrical connection between the first and second ends of the first switch SW1 and to make the electrical connection between the first and second ends of the second switch SW2. A voltage at the bias voltage output terminal O of the first one of the voltage boosting circuits VAC1 in the series connection is substantially equal to that at the second end of the first capacitor C1, i.e., 2VDD.

Subsequently, the first end of the first capacitor C1 of the second one of the voltage boosting circuits VAC2 in the series connection is coupled electrically to the second end of the first capacitor C1 of the first one of the voltage boosting circuits VAC1 in the series connection so as to have a voltage of 2VDD. Moreover, since the first capacitor C1 of the second one of the voltage boosting circuits VAC2 in the series connection has been fully charged during a previous time cycle so as to have a cross voltage of VDD, the second end of the first capacitor C1 thereof has a voltage of 3VDD=2VDD+VDD. The voltage of 3VDD (>2VDD) is applied onto the control ends of the third and fourth switches SW3, SW4 so as to make the electrical connection between the first and second ends of the third switch SW3 and to break the electrical connection between the first and second ends of the fourth switch SW4. A flow of electric current from the bias voltage input terminal I of the second one of the voltage boosting circuits VAC2 in the series connection charges the second capacitor C2 thereof such that the second end of the second capacitor C2 has a voltage of 2VDD=VDD+VDD. The voltage of 2VDD (<3VDD) is applied onto the control ends of the first and second switches SW1, SW2 so as to break the electrical connection between the first and second ends of the first switch SW1 and to make the electrical connection between the first and second ends of the second switch SW2. A voltage at the bias voltage output terminal O of the second one of the voltage boosting circuits VAC2 in the series connection is substantially equal to that at the second end of the first capacitor C1 thereof, i.e., 3VDD.

It may be derived from the above description that a voltage at the bias voltage output terminal O of the third one of the voltage boosting circuits VAC3 in the series connection is substantially equal to that at the second end of the first capacitor C1 thereof, i.e., 4VDD. Further, since the voltage booster VAC is substantially symmetric in design, a second operation mode of the voltage boosting circuits VAC1˜VAC3 in the series connection may be reasoned by analogy (see FIG. 4), such that details of the same are omitted herein for the sake of brevity.

To sum up, a cross voltage at the second end with respect to the first end of each of the first and second capacitors C1, C2 in the voltage booster VAC of the preferred embodiment does not increase along with the number of the voltage boosting circuits VAC1˜VAC(N) in the series connection of the voltage booster VAC. Therefore, each of the first and second capacitors C1, C2 in the preferred embodiment is not required to be composed of a plurality of sub-capacitors connected in series, so as to save an overall chip area of the charge pump.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A charge pump comprising:
a timing signal generator configured for generating a first timing signal and a second timing signal that is an inverse of the first timing signal; and
a voltage booster including a series connection of a plurality of voltage boosting circuits, each of said voltage boosting circuits including
a bias voltage input terminal,
a bias voltage output terminal,
a first capacitor having a first end and a second end,
a second capacitor having a first end and a second end, and
a switch module coupled electrically to said bias voltage input terminal, said bias voltage output terminal, and said second ends of said first and second capacitors, and controllable to switch between a first state, in which electrical connection is established between said second end of said first capacitor and said bias voltage output terminal and between said second end of said second capacitor and said bias voltage input terminal, and a second state, in which electrical connection is established between said second end of said first capacitor and said bias voltage input terminal and between said second end of said second capacitor and said bias voltage output terminal;
wherein said bias voltage input terminal of a first one of said voltage boosting circuits in the series connection is adapted to receive an input bias voltage signal, said bias voltage input terminal of each of succeeding ones of said voltage boosting circuits in the series connection being coupled electrically to said bias voltage output terminal of an immediately preceding one of said voltage boosting circuits in the series connection, each of said voltage boosting circuits being configured to boost a voltage signal received at said bias voltage input terminal thereof and to output the voltage signal boosted thereby from said bias voltage output terminal thereof, said bias voltage output terminal of a last one of said voltage boosting circuits in the series connection being adapted to provide an output bias voltage;
wherein said first end of said first capacitor of said first one of said voltage boosting circuits in the series connection is coupled electrically to said timing signal generator for receiving the first timing signal, and said first end of said first capacitor of each of said succeeding ones of said voltage boosting circuits in the series connection is coupled electrically to said second end of said first capacitor of said immediately preceding one of said voltage boosting circuits in the series connection;
wherein said first end of said second capacitor of said first one of said voltage boosting circuits in the series connection is coupled electrically to said timing signal generator for receiving the second timing signal, and said first end of said second capacitor of each of said succeeding ones of said voltage boosting circuits in the series connection is coupled electrically to said second end of said second capacitor of said immediately preceding one of said voltage boosting circuits in the series connection.

2. The charge pump as claimed in claim 1, wherein, when the first timing signal is at a logic 1 state and the second timing signal is at a logic 0 state, said switch module of each of said voltage boosting circuits is controlled to operate in the first state.

3. The charge pump as claimed in claim 1, wherein, when the first timing signal is at a logic 0 state and the second timing signal is at a logic 1 state, said switch module of each of said voltage boosting circuits is controlled to operate in the second state.

4. The charge pump as claimed in claim 1, wherein said switch module includes:
a first switch having a first end coupled electrically to said respective bias voltage input terminal, a second end coupled electrically to said second end of said respective first capacitor, and a control end coupled electrically to said second end of said respective second capacitor, said control end being controllable to make or break electrical connection between said first and second ends of said first switch;
a second switch having a first end coupled electrically to said second end of said respective first capacitor, a second end coupled electrically to said respective bias voltage output terminal, and a control end coupled electrically to said second end of said respective second capacitor, said control end of said second switch being controllable to make or break electrical connection between said first and second ends of said second switch;
a third switch having a first end coupled electrically to said respective bias voltage input terminal, a second end coupled electrically to said second end of said respective second capacitor, and a control end coupled electrically to said second end of said respective first capacitor, said control end of said third switch being controllable to make or break electrical connection between said first and second ends of said third switch; and
a fourth switch having a first end coupled electrically to said second end of said respective second capacitor, a second end coupled electrically to said respective bias voltage output terminal, and a control end coupled electrically to said second end of said respective first capacitor, said control end of said fourth switch being controllable to make or break electrical connection between said first and second ends of said fourth switch.

5. The charge pump as claimed in claim 4, wherein:
each of said first and third switches is an N-type metal-oxide-semiconductor field-effect transistor (MOSFET) having source, drain and gate terminals serving as said first end, said second end and said control end, respectively; and
each of said second and fourth switches is a P-type MOSFET having drain, source and gate terminals serving as said first end, said second end and said control end, respectively.

6. The charge pump as claimed in claim 1, further comprising an output capacitor which has a first end coupled electrically to said bias voltage output terminal of said last one of said voltage boosting circuits in the series connection, and a grounded second end.

7. The charge pump as claimed in claim 1, wherein said timing signal generator includes:
a first inverter having an input end for receiving a reference timing signal, and an output end for outputting the first timing signal; and
a second inverter having an input end coupled electrically to said output end of said first inverter, and an output end for outputting the second timing signal.

8. A voltage booster to be utilized in a charge pump, the charge pump including a timing signal generator for generating a first timing signal and a second timing signal that is an inverse of the first timing signal, said voltage booster comprising a series connection of a plurality of voltage boosting circuits, each of said voltage boosting circuits including:
a bias voltage input terminal,
a bias voltage output terminal,
a first capacitor having a first end and a second end,
a second capacitor having a first end and a second end, and
a switch module coupled electrically to said bias voltage input terminal, said bias voltage output terminal, and said second ends of said first and second capacitors, and controllable to switch between a first state, in which electrical connection is established between said second end of said first capacitor and said bias voltage output terminal and between said second end of said second capacitor and said bias voltage input terminal, and a second state, in which electrical connection is established between said second end of said first capacitor and said bias voltage input terminal and between said second end of said second capacitor and said bias voltage output terminal;
wherein said bias voltage input terminal of a first one of said voltage boosting circuits in the series connection is adapted to receive an input bias voltage signal, said bias voltage input terminal of each of succeeding ones of said voltage boosting circuits in the series connection being coupled electrically to said bias voltage output terminal of an immediately preceding one of said voltage boosting circuits in the series connection, each of said voltage boosting circuits being configured to boost a voltage signal received at said bias voltage input terminal thereof and to output the voltage signal boosted thereby from said bias voltage output terminal thereof, said bias voltage output terminal of a last one of said voltage boosting circuits in the series connection being adapted to provide an output bias voltage;
wherein said first end of said first capacitor of said first one of said voltage boosting circuits in the series connection is coupled electrically to said timing signal generator for receiving the first timing signal, and said first end of said first capacitor of each of said succeeding ones of said voltage boosting circuits in the series connection is coupled electrically to said second end of said first capacitor of said immediately preceding one of said voltage boosting circuits in the series connection;
wherein said first end of said second capacitor of said first one of said voltage boosting circuits in the series connection is coupled electrically to said timing signal generator for receiving the second timing signal, and said first end of said second capacitor of each of said succeeding ones of said voltage boosting circuits in the series connection is coupled electrically to said second end of said second capacitor of said immediately preceding one of said voltage boosting circuits in the series connection.

9. The voltage booster as claimed in claim 8, wherein, when the first timing signal is at a logic 1 state and the second timing signal is at a logic 0 state, said switch module of each of said voltage boosting circuits is controlled to operate in the first state.

10. The voltage booster as claimed in claim 8, wherein, when the first timing signal is at a logic 0 state and the second timing signal is at a logic 1 state, said switch module of each of said voltage boosting circuits is controlled to operate in the second state.

11. The voltage booster as claimed in claim 8, wherein said switch module includes:
a first switch having a first end coupled electrically to said respective bias voltage input terminal, a second end coupled electrically to said second end of said respective first capacitor, and a control end coupled electrically to said second end of said respective second capacitor, said control end being controllable to make or break electrical connection between said first and second ends of said first switch;
a second switch having a first end coupled electrically to said second end of said respective first capacitor, a second end coupled electrically to said respective bias voltage output terminal, and a control end coupled electrically to said second end of said respective second capacitor, said control end of said second switch being controllable to make or break electrical connection between said first and second ends of said second switch;
a third switch having a first end coupled electrically to said respective bias voltage input terminal, a second end coupled electrically to said second end of said respective second capacitor, and a control end coupled electrically to said second end of said respective first capacitor, said control end of said third switch being controllable to make or break electrical connection between said first and second ends of said third switch; and
a fourth switch having a first end coupled electrically to said second end of said respective second capacitor, a second end coupled electrically to said respective bias voltage output terminal, and a control end coupled electrically to said second end of said respective first capacitor, said control end of said fourth switch being controllable to make or break electrical connection between said first and second ends of said fourth switch.

12. The voltage booster as claimed in claim 11, wherein:
each of said first and third switches is an N-type metal-oxide-semiconductor field-effect transistor (MOSFET) having source, drain and gate terminals serving as said first end, said second end and said control end, respectively; and
each of said second and fourth switches is a P-type MOSFET having drain, source and gate terminals serving as said first end, said second end and said control end, respectively.
